(19) United States
(12) Patent Application Publication
(10) Pub. No.: US 2004/0071466 A1
(43) Pub. Date: Apr. 15, 2004

(54) Controlled optical splitter using a diffractive optical element and optical demultiplexer incorporating same

(76) Inventors: Lisa A. Buckman, San Francisco, CA (US); Jonathan Simon, Castro Valley, CA (US); Ian Hardcastle, Sunnyvale, CA (US)

Correspondence Address: AGILENT TECHNOLOGIES, INC., Legal Department, DL429, P.O. Box 7599, Loveland, CO, 80537-0599, US

(21) Appl. No.: 10/269,782

(22) Filed: Oct. 10, 2002

(51) Int. Cl. G02F 1/00

(52) U.S. Cl. 398/1

(57) ABSTRACT

The optical splitter includes a diffractive optical element (DOE) to create a generally two-dimensional array of beams of light from an input light beam. Each beam carries substantially identical information content. The intensity and the position of each element of the array of beams may be controlled. In addition, an embodiment of the invention is an optical demultiplexer that comprises the above optical splitter.

### BACKGROUND OF THE INVENTION

1. Field of the Invention

This invention relates to optical splitters and optical demultiplexers and, more specifically, to an optical splitter using a diffractive optical element and an optical demultiplexer incorporating such optical splitter.

2. Discussion of the Related Art

With the demand for higher speed or increased bandwidth, or both, in all levels of communications systems, optical components or devices play an increasing role in the communications systems. Such communications systems include wide area networks (WAN) having optical sub-systems, or formed entirely of optical components, examples of which may include a trunk line. The communications systems may further include metropolitan area networks (MAN), storage area networks (SAN), local area networks (LAN), or a combination of such networks. For example, fiber-to-the-curb applications for residential subscribers need optical devices, especially passive optical devices, for combining sub-networks together. High bandwidth data transmission systems transmit multiple wavelengths of light via a single optical fiber in order to increase the total capacity of a link such as an optical link.

Communications systems of the type identified above typically involve light signals having multiple wavelengths. One reason for the above is that the total data carrying capacity of optical systems that use multiple wavelengths is increased compared to optical systems that use single wavelengths and non-optical systems such as copper wire. One or more optical splitters, and/or optical demultiplexers, may be required somewhere within the communication system, such as on the receiver side. An optical splitter is used for separating an input light beam into divisional light beams that possess substantially identical information content as one another and as the input light beam. A demultiplexer is employed for separating an input light beam into its constituent wavelengths or channels before going to a destination such as a photodetector.

Conventional optical demultiplexers and optical splitters can be bulky or large, therefore occupying precious space. Therefore, it is desirable to have simpler, more compact devices for splitting a light beam into a plurality of divisional light beams and/or for demultiplexing a light beam into its constituent wavelengths or channels.

### SUMMARY OF THE INVENTION

Broadly speaking, embodiments of the invention provide simple, compact structures for splitting an input light beam into a plurality of divisional light beams and/or for demultiplexing an input light beam into its constituent wavelengths or channels.

One embodiment of the present invention includes an optical splitter that receives an input light beam. This optical splitter comprises a diffractive optical element (DOE) having a first surface for receiving the input light beam, and at least a second surface for progressing at least part of a plurality of divisional light beams. The optical splitter also comprises an image plane having a plurality of locations or encounter spots for passing the plurality of divisional light beams therethrough, whereby each of the split divisional light beams is processed individually, independently of each other.

Another embodiment of the present invention relates to an optical demultiplexer that comprises the above-described optical splitter and a plurality of filters, each receiving one of the plurality of divisional light beams coming from the image plane. Each filter is selected to pass a predetermined wavelength from the input light beam so that the information content of each predetermined wavelength of the input light beam is received by a respective receiving element.

Yet another embodiment of the present invention is directed to a communication system. The communication system comprises a diffractive optical element for receiving an input light beam, splitting the input light beam into a plurality of divisional light beams, and transmitting the divisional light beams. The communication system additionally comprises a plurality of receiving elements for receiving the plurality of divisional light beams. The receiving elements may comprise respective optical filters for filtering the plurality of divisional light beams. Each filter is provided for selecting a predetermined wavelength from the input light beam. The communication system may additionally comprise a plurality of filters for filtering the plurality of divisional light beams prior to the receivers. Each filter is selected to pass a different one of the constituent wavelengths of the input light beam so that the information content contained within each constituent wavelength of the input light beam is passed to a different one of the receivers. In this case, the receiving elements receive the filtered light beams passed through respective ones of said optical filters, where each filtered light beam has a predetermined wavelength.

The present invention further provides a method for processing an input light beam. In the method, a diffractive optical element is illuminated with the input light beam. The input light beam is divided into at least two divisional beams that are directed in predetermined, independent directions by means of the diffractive optical element.

### BRIEF DESCRIPTION OF THE DRAWING

These and other features, aspects and advantages of the present invention will become better understood with reference to the following drawing, wherein:

FIG. 1 is a schematic depiction of an optical splitter using a diffractive optical element in accordance with the invention;

FIG. 2 is a schematic depiction of an optical demultiplexer including the optical splitter of FIG. 1;

FIG. 3 is a schematic depiction of a communication system using the optical demultiplexer of FIG. 2;

FIG. 4 is a schematic depiction of a communication system having a passive optical network using the optical splitter of FIG. 1 or the optical demultiplexer of FIG. 2; and

FIG. 5 is a flow diagram of the method of processing an input light signal in accordance with the invention.

### DETAILED DESCRIPTION OF THE PREFERRED EMBODIMENTS

The following is a detailed description of a preferred mode as contemplated for carrying out the invention. The description is not to be taken in a limiting sense, but is made merely for the purpose of illustrating the general principles of the invention, since the scope of the invention is defined by the appended claims.

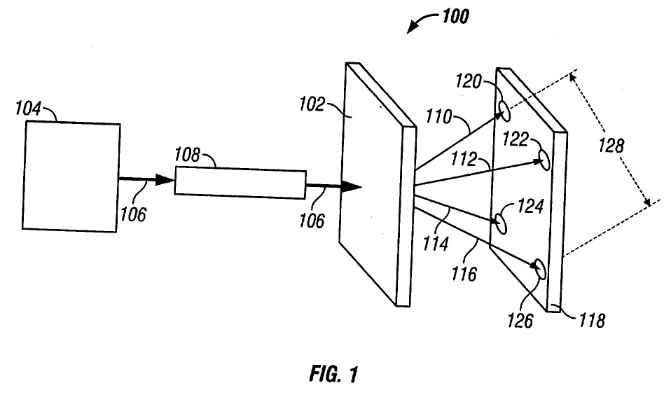

Referring to FIG. 1, optical splitter 100 using diffractive optical element (DOE) 102 is shown. Light source 104 emits input light beam 106 by way of free space or, alternatively, by way of a conduit such as optical fiber 108 in which light beams propagate from one end of the optical fiber to the other end. As can be appreciated, input light beam 106 comprises at least one separate and independent wavelength. It is contemplated that input light beam 106 will have a plurality of wavelengths. The plurality of wavelengths is represented by the thicker lines of the arrow that depicts the input light beam. Input light beam 106, in turn, passes through diffractive optical element 102 and is split into a plurality of divisional light beams (only four are shown) 110, 112, 114, and 116.

Diffractive optical element 102 is a passive element in that input light beam 106 is not amplified or regenerated. The DOE may be constructed to divide input light beam 106 into beams such as divisional light beams 110, 112, 114, and 116. Absent attenuation and loss due to DOE 102 or similar factors, ideally the summation of the intensities of the divisional light beams should equal the intensity of input light beam 106. Each of the divisional light beams from the DOE may be of equal or unequal intensity. For example, beam 110 may have different intensity than beam 116. However, the information content of input light beam 106 is identical or substantially identical with that of each divisional light beam 110, 112, 114, and 116. That is to say, for example, while the intensity of divisional light beam 110 may be different from that of input light beam 106, the information content contained within or transmitted by both divisional light beam 110 and input light beam 106 is identical or substantially identical. One reason for the above is because when the input light beam is split by DOE 102, only the optical power level or intensity of beam 106 is divided or segmented. The intensity of the input light beam is distributed among the divisional light beams. However, absent loss by reason of the DOE or other proximal conditions, information content such as data contained within the input light beam is transmitted intact or in an identical manner within each divisional light beam. It is noted that input light beam 106 may comprise multi-wavelength light beams.

Output plane 118 receives the divisional light beams or is positioned to intersect the divisional light beams. Output plane 118 may be an image plane, wherein each and every one of divisional light beams 110, 112, 114, and 116 is at an appropriate spacing as determined by DOE 102. In other words, opposite from the input side of the DOE there exists output plane 118. There may not be any physical element that is representative of output plane 118, that is, it may be a virtual plane, but the plane location exists for any suitable device that may later be positioned there. Output plane 118 exists for the purpose of some applications such as the location of light encounter spots thereon. That is to say, each and every one of divisional light beams 110, 112, 114, and 116 encounters or intersects output plane 118 at the appropriate spacing forming a plurality of encounter spots on or at the output plane. The characteristics of the encounter spots and their positions at the output plane are determined by the characteristics of the DOE. Encounter spots 120, 122, 124, and 126 at output plane 118 form an array of points through which the divisional light beams pass. For example, encounter spot 120 corresponds to light beam 110, encounter spot 122 corresponds to light beam 112, encounter spot 124 corresponds to light beam 114, and encounter spot 126 corresponds to light beam 116.

As can be appreciated, output plane 118 may merely be a reference plane without a physical existence, or it may be a device with a structure for a suitable purpose. In place of an actual physical image plane, at the location of output plane 118 there may be an array of collimating lenses to collimate the light beams and send them on to an array of receivers or photodiodes, or an array of fibers to collect the light.

Furthermore, the relative positions of the encounter spots need not be symmetrical. Some embodiments of the instant invention may require optical splitter 100 to split light into divisional light beams having respective encounter spots located in an asymmetrical layout or array. The array may be a two-dimensional flat plane, or it may be a plurality of two-dimensional flat planes. This way, if is desired that two encounter spots be separated by a predetermined distance, DOE 102 may be constructed in such a way that achieves this predetermined distance. It should be noted that every one of divisional light beams 110, 112, 114, and 116 is still a light beam upon passing through respective encounter spots 120, 122, 124, and 126.

By way of an example, there may be a first device (not shown) to be coupled to divisional light beam 110, and a second device (also not shown) to be coupled to divisional light beam 116. Both first device and second devices would have an initial contact point with respective light beams 110 and 116. There may be a requirement that the initial contact points stay apart by a predetermined distance 128. The reason for the predetermined distance may comprise, among other things, the external shape of either the first or the second device, or both, or to prevent crosstalk between light beams 110 and 116, respectively.

If output plane 118 is connected to a device with a structure, then the shape of the plane shown in FIG. 1 may be different for the purpose of the instant invention. Both the DOE and output plane 118 are shown as having significant thickness and a rectangular periphery. The shapes shown are for ease of depiction only and these elements may have any suitable shape.

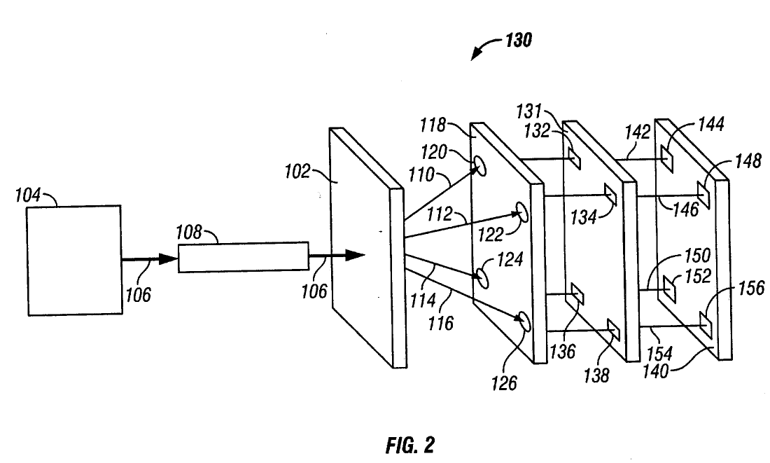

Referring to FIG. 2, optical demultiplexer 130 includes the optical splitter of FIG. 1. Light source 104 emits input light beam 106 as previously described. Input light beam 106, in turn, passes through DOE 102 and is split into a plurality of divisional light beams (only four shown) 110, 112, 114, and 116, as before. The characteristics of the light beams are the same as previously described with respect to FIG. 1.

Output plane 118, having a plurality of beam locations or encounter spots (only four are shown), receives the divisional light beams as previously described.

Filter plane 131, comprising an array of filters, only four of which are shown, selectively filters the desired wavelengths for each light beam. Thus, for a light beam that comprises multiple wavelengths, a filter may be selected to selectively pass one, or some, of the multiple wavelengths out of the total of the wavelengths in the beam. In other words, a filter serves the usual purpose of blocking unwanted wavelengths included in the light beam. The shown filters are, respectively, filter 132 associated with spot 120 which receives divisional light beam 110, filter 134 associated with spot 122 which receives divisional light beam 112, filter 136 associated with spot 124 which receives divisional light beam 114, and filter 138 associated with spot 126 which receives divisional light beam 116.

In turn, the filtered light beams are received, respectively, by a receiving array 140 of receiving elements such as photodetectors (also only four are shown), which transform light signals into other types of signals, such as electrical signals. Filtered light beam 142 from filter 132 is received by detector 144 on receiving array 140. Filtered light beam 146 from filter 134 is received by detector 148. Filtered light beam 150 from filter 136 is received by detector 152. Filtered light beam 154 from filter 138 is received by detector 156. The relative positions of the filters in filter plane 131 may be other than symmetrical. If it is desired that two filters be spaced by a predetermined distance, plane 131 may be constructed in such a way that achieves this predetermined distance. For the same reasons the relative positions of the receiving elements on receiving array 140 may not necessarily be symmetrical. Receiving elements may include optical fibers or other types of optical waveguides.

As with DOE 102 and output plane 118, the shapes of filter plane 131 and receiving array 140, as shown in FIG. 2, may be different for purposes of the instant invention. The shapes shown are for ease of depiction only.

Light source 104 may be a laser and input light beam 106 may be laser light beam. Different laser beams possess dissimilar qualities. Some lasers, such as the helium-neon lasers, may have a very well collimated beam by their nature. Others, such as semiconductor diode lasers, may have a beam that is very broad or expanding. A collimating lens (not shown) may be positioned between light source 104 and DOE 102 in order to collimate the light beam. The collimating lens may be either independent of DOE 102, or the DOE may be structured to provide collimation. In addition, this collimating process may be applied to any one of divisional light beams 110, 112, 114, and 116. For example, an array of lenses may be placed in the proximity of encounter spots 120, 122, 124, and 126 to collimate the divisional light beams.

The instant invention contemplates the use of DOE 102 to split input light beam 106 into a plurality of divisional light beams. The DOE may be constructed in such a way that the divisional light beams coming out of the DOE may have qualities such as different intensities, or be emitted toward different directions and positions on image or output plane 118. Furthermore, the dimensions of DOE 102 may be very compact, thereby optical splitter 100 and optical demultiplexer 130 occupy as little valuable space as possible.

Referring to FIG. 3, an optical communication system 200 using wavelength-division multiplexing (WDM) is shown. In the optical communication system, a single fiber transmits a multi-wavelength input light beam. Each wavelength transmits data at high speed. For example, a wavelength may transmit data at a multi-gigabit per second data rate. It is noted that only a single direction transmission is depicted, whereas in most real world cases, transmission is bi-directional.

Optical fiber 202, having a first end 204 and second end 206 and disposed to carry an input light beam having plurality of wavelengths, is provided for transmission of the input light beam from the first end to the second end. Input light beam 208 typically comprises a plurality of constituent wavelengths, each of which originates from its respective source, such as transmission devices 210, 212, and 214. The transmission devices may each be any suitable device such as a laser at the output end of a server, a router, or a mainframe computer system. The constituent wavelengths initially pass through a wavelength division multiplexer (MUX) 216, which multiplexes the constituent wavelengths to form input light beam 208 that is suitable for transmission. After transmission through optical fiber 202, input light beam 208 is coupled to demultiplexer (DEMUX) 218. Demultiplexer 218 is a demultiplexer similar to demultiplexer 130 shown in FIG. 2. Demultiplexer 218 directs an individual wavelength originating from any one of transmission devices 210, 212, and 214 and combined into input light beam 208 to a respective one of receiving devices 220, 222, and 224.

Demultiplexer 218 incorporates a simple optical splitter based on a diffractive optical element and similar to optical splitter 100 shown in FIG. 1. The optical splitter divides the information content of light beam 208 into a plurality of divisional beams that are filtered to extract a single wavelength. The filtered beams terminate at receiving devices 220, 222, and 224, respectively.

Some transmission losses may occur in optical fiber 202, and losses may occur through DEMUX 218. Moreover, filtered light beams 226, 228, and 230 may collectively contain fewer wavelengths than input light beam 208 if the demultiplexer filters out some wavelengths of the input light beam. In addition, appropriate spacing is provided among the divisional light beams and among the filtered light beams to minimize crosstalk between the different wavelengths. The optical demultiplexer 130 of FIG. 2 can provide this characteristic, as discussed previously.

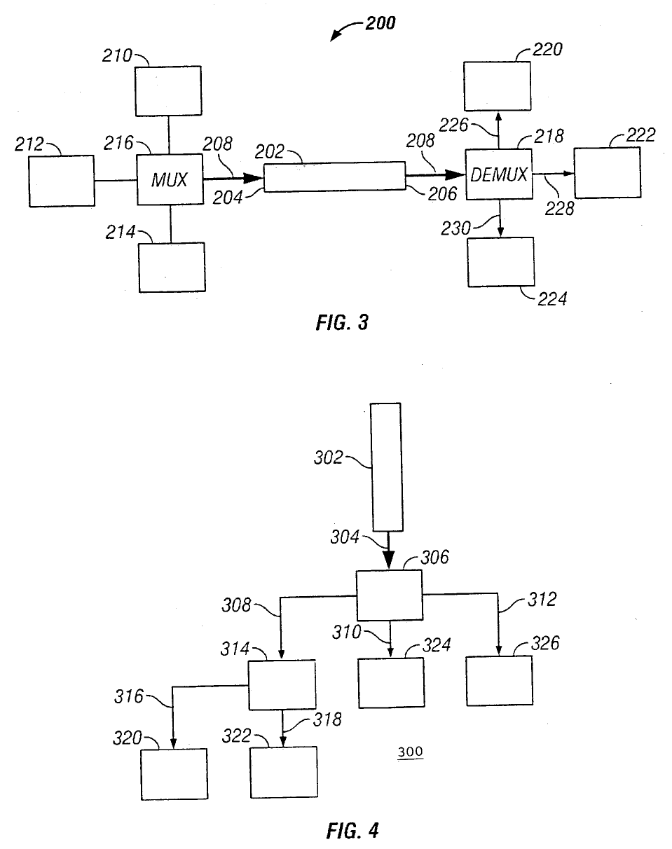

FIG. 4 shows passive optical communication system 300. High-capacity optical fiber 302 routes input light beam 304, which may be a multi-wavelength light beam, from a local link (not shown), where all the light beams transmit along the link, to all the terminal devices (discussed below). Optical splitter 306 receives input light beam 304 and splits the input light beam into a plurality of divisional light beams (only three are shown). Each of divisional light beams 308, 310, and 312 has identical or substantially identical information content in relation to each other, as well as in relation to input light beam 304. In other words, splitter 306 merely divides input optical signal 304 into a plurality of divisional light beams, each having a lower optical intensity. Since this system is a passive optical system, the light beams are not enhanced, amplified, or regenerated in any way. Therefore, if input light beam 304 is split, the resulting divisional signals necessarily possess a lower optical intensity than that of input light beam 304. Furthermore, the optical intensity of divisional light beams 308, 310, and 312 may be different in relation to each other by means of controlling the internal structure of optical splitter 306, as mentioned above. Optical splitter 306 may possess similar or identical structure as that of the optical splitter described in FIG. 1.

Divisional light beam 308 is transmitted to intermediate device 314, which may comprise structure which is similar or identical to that of the optical splitter described in FIG. 1. Intermediate device 314 transmits sub-divisional light beams 316, 318 to terminal or receiving devices 320 and 322, respectively. Terminal devices 320 and 322 may comprise optical network units for such purposes as interfacing a subscriber's analog access cables with the fiber facilities including, for example, the ones described in FIG. 4.

With regard to divisional light beams 310 and 312, they terminate directly into terminal devices 324 and 326, respectively. Similarly, terminal devices 324 and 326 may comprise optical network units for interfacing a subscriber's analog access cables with the fiber facilities including, for example, the ones described here.

In place of optical splitter 314, an optical demultiplexer as described in FIG. 2 may be employed. This may be useful where any one of terminal devices 324 and 326 is required to receive light beams of only a predetermined wavelength.

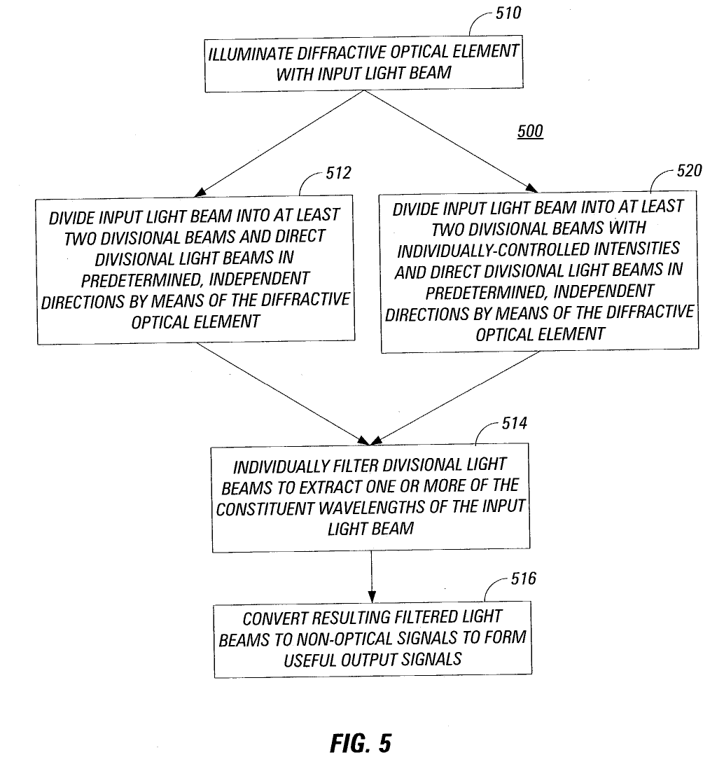

The flow diagram of FIG. 5 illustrates a method according to the invention for processing an input light beam. In block 510, a diffractive optical element is illuminated with the input light beam. In block 512, the input light beam is divided into several divisional light beams and the divisional light beams are directed in predetermined, independent directions by means of the DOE. The divisional light beams each carry the entire information content of the input light beam. An input light beam that is a multi-wavelength input light beam may be further processed as follows. In block 514, the divisional light beams are individually filtered to extract one or more of the constituent wavelengths of the input light beam. In block 516, the resulting filtered light beams are converted to non-light signals to form useful output signals.

FIG. 5 also shows alternative processing that may be performed by the DOE. In block 520, the DOE divides the input light beam to provide the divisional beams with individually-controlled intensities. This is another possible feature of the DOE as contemplated for the communication system of the invention.

The instant invention teaches the use of a diffractive optical element to create an array of divisional light beams from an input light beam. The DOE slits the input light beam into multiple divisional light beams each carrying the same information as the input light beam. The DOE allows the intensity and position of each divisional light beam to be controlled.

In some applications, the input light beam traveling on an optical fiber carries multiple wavelengths of light with each wavelength carrying independent data. On the receiver end of the optical fiber, the input light beam may need to be separated into its constituent wavelengths. A DOE is used to create copies of the input light beam output by the optical fiber. Each copy of the input light beam carries all the wavelengths of the original input light beam. After the input light beam has been split into multiple divisional light beams, each divisional light beam is passed through an optical filter to select a predetermined wavelength. In addition to creating an array of divisional light beams from a given input light beam, the DOE may be designed to provide a desired pattern of divisional light beams allowing flexibility for the location and spacing of the divisional light beams. Further, the DOE may be designed to provide each divisional light beam with a different intensity. In the instant invention, the DOE is used as an optical splitter that provides flexibility in the optical intensity of each divisional light beam and in the physical location of each divisional light beam.

It should be understood, of course, that the foregoing relates to preferred embodiments of the invention and that modifications may be made without departing from the intent and scope of the invention as set forth in the following claims and their equivalents.

What is claimed is:

1. An optical splitter configured to receive an input light beam for splitting, the optical splitter comprising:
a diffractive optical element having a first surface for receiving the input light beam, and at least a second surface for progressing a plurality of divisional light beams; and
an output plane having a plurality of encounter spots for passing the plurality of divisional light beams therethrough for processing individually and independently of each other.

2. The optical splitter of claim 1, wherein the direction of each of the plurality of divisional light beams is controlled by said diffractive optical element.

3. The optical splitter of claim 1, wherein the intensity of each of the plurality of divisional light beams is controlled by said diffractive optical element.

4. The optical splitter of claim 1, wherein each divisional light beam has information content that is substantially identical to the input light beam.

5. The optical splitter of claim 1, wherein the sum total of optical power level of the plurality of divisional light beams substantially equals the optical power level of the input light beam after accounting for the insertion loss of the optical splitter.

6. An optical demultiplexer configured to receive an input light beam comprising a plurality of wavelengths, the demultiplexer comprising:
said optical splitter of claim 1; and
a plurality of filters for receiving the plurality of divisional light beams coming from said second surface, each said filter being provided for selecting a predetermined wavelength from the input light beam.

7. The optical demultiplexer of claim 6, wherein the direction of each of the plurality of divisional light beams is controlled by said diffractive optical element.

8. The optical demultiplexer of claim 6, wherein the intensity of each of the plurality of divisional light beams is controlled by said diffractive optical element.

9. The optical demultiplexer of claim 6, wherein each of the plurality of divisional light beams has an information content of substantially identical to the input light beam.

10. The optical demultiplexer of claim 6, wherein the sum total of optical power level of the plurality of divisional light beams substantially equals the optical power level of the input light beam after subtracting the insertion loss of the optical splitter.

11. A communication system, comprising:
a diffractive optical element for receiving an input light beam, splitting the input light beam into a plurality of divisional light beams, and transmitting the divisional light beams; and
a plurality of receiving elements for receiving the divisional light beams.

12. The communication system of claim 11, wherein the input light beam comprises a plurality of wavelengths.

13. The communication system of claim 11, wherein said communication system comprises a passive optical network.

14. The communication system of claim 11, wherein said communication system comprises a wavelength-division multiplexing network.

15. The communication system of claim 11, further comprising a plurality of optical elements for passing the plurality of divisional light beams.

16. The communication system of claim 15, wherein said plurality of optical elements comprises lenses.

17. The communication system of claim 15, wherein said plurality of optical elements comprises optical filters.

18. The communication system of claim 11, wherein said receiving elements comprise photodetectors.

19. The communication system of claim 11, wherein:
the communication system additionally comprises a plurality of optical filters for filtering the plurality of divisional light beams, each filter being provided for selecting a predetermined wavelength from the input light beam; and
said receiving elements are for receiving the filtered light beams passed through respective ones of said optical filters, where each filtered light beam has a predetermined wavelength.

20. The communication system of claim 19, further comprising a plurality of optical elements for passing the plurality of divisional light beams.

21. The communication system of claim 20, wherein the plurality of optical elements comprises lenses.

22. The communication system of claim 19, wherein said receiving elements comprise photodetectors.

23. The communication system of claim 19, wherein the communication system comprises a passive optical network.

24. The communication system of claim 19, wherein the communication system comprises a wavelength-division multiplexing network.

25. The communication system of claim 19, additionally comprising at least one laser providing the input light beam.

26. A method for processing an input light beam, comprising:
illuminating a diffractive optical element with the input light beam; and
dividing the input light beam into at least two divisional beams and directing the divisional beams in predetermined, independent directions by means of the diffractive optical element.

27. The method of claim 26, further comprising inputting the divisional light beams into respective optical filters.

28. The method of claim 27, further comprising converting the filtered divisional light beams into non-light signals.

29. The method of claim 26, further comprising controlling the intensity of the divisional light beams by means of the diffractive optical element so that each divisional beam has an individually-controlled intensity.
